(19) United States
(12) Patent Application Publication
(10) Pub. No.: US 2009/0187652 A1
(43) Pub. Date: Jul. 23, 2009

(54) Inferred Discovery Of Devices Of A Data Communications Network

(75) Inventor: Nicholas Ho, Denver, CO (US)

Correspondence Address: INTERNATIONAL CORP (BLF), c/o BIGGERS & OHANIAN, LLP, P.O. BOX 1469, AUSTIN, TX, 78767-1469, US

(73) Assignee: INTERNATIONAL BUSINESS MACHINES CORPORATION, ARMONK, NY (US)

(21) Appl. No.: 12/017,074

(22) Filed: Jan. 21, 2008

(51) Int. Cl. G06F 15/173

(52) U.S. Cl. 709/224

(57) ABSTRACT

Methods, apparatus, and products for inferred discovery of devices of a data communications network are described. In embodiments of the present invention the data communications network includes a plurality of data communications devices connecting a plurality of routers, each data communications device having a device address, each router having one or more network interfaces. Embodiments of the present invention also include querying each router for connection data, the connection data associating interfaces of the router with device addresses; identifying for each router in dependence upon the connection data an interface of the router connected to a data communications device including identifying a device address associated with the interface; and creating, in dependence upon the identified device addresses for all routers, a representation of the data communications network in a network model.

### BACKGROUND OF THE INVENTION

1. Field of the Invention

The field of the invention is data processing, or, more specifically, methods, apparatus, and products for inferred discovery of devices of a data communications network.

2. Description of Related Art

The development of the EDVAC computer system of 1948 is often cited as the beginning of the computer era. Since that time, computer systems have evolved into extremely complicated devices. Today's computers are much more sophisticated than early systems such as the EDVAC. Computer systems typically include a combination of hardware and software components, application programs, operating systems, processors, buses, memory, input/output devices, and so on. As advances in semiconductor processing and computer architecture push the performance of the computer higher and higher, more sophisticated computer software has evolved to take advantage of the higher performance of the hardware, resulting in computer systems today that are much more powerful than just a few years ago.

Large enterprises typically connect computers at remote locations as a virtual private network across a third-party network. The third-party network is typically not owned or managed by the enterprise, rather the network is owned and operated by an internet service provider. Typically customer computers and data communications at the remote location have no knowledge of the provider data communications devices that make up the provider network. Without knowledge of such devices a customer network management tool is unable to create an accurate network model or accurately perform root cause analysis on the customer devices connected through a provider network. In such a case it may be difficult if not impossible to determine an actual cause of a network malfunction.

### SUMMARY OF THE INVENTION

Methods, apparatus, and products for inferred discovery of devices of a data communications network are described. In embodiments of the present invention the data communications network includes a plurality of data communications devices connecting a plurality of routers, each data communications device having a device address, each router having one or more network interfaces. Embodiments of the present invention also include querying each router for connection data, the connection data associating interfaces of the router with device addresses; identifying for each router in dependence upon the connection data an interface of the router connected to a data communications device including identifying a device address associated with the interface; and creating, in dependence upon the identified device addresses for all routers, a representation of the data communications network in a network model.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a functional block diagram of an exemplary system capable of inferred discovery of devices of a data communications network according to embodiments of the present invention.

FIG. 2 sets forth a flow chart illustrating an exemplary method for inferred discovery of devices of a data communications network according to embodiments of the present invention.

### DETAILED DESCRIPTION OF EXEMPLARY EMBODIMENTS

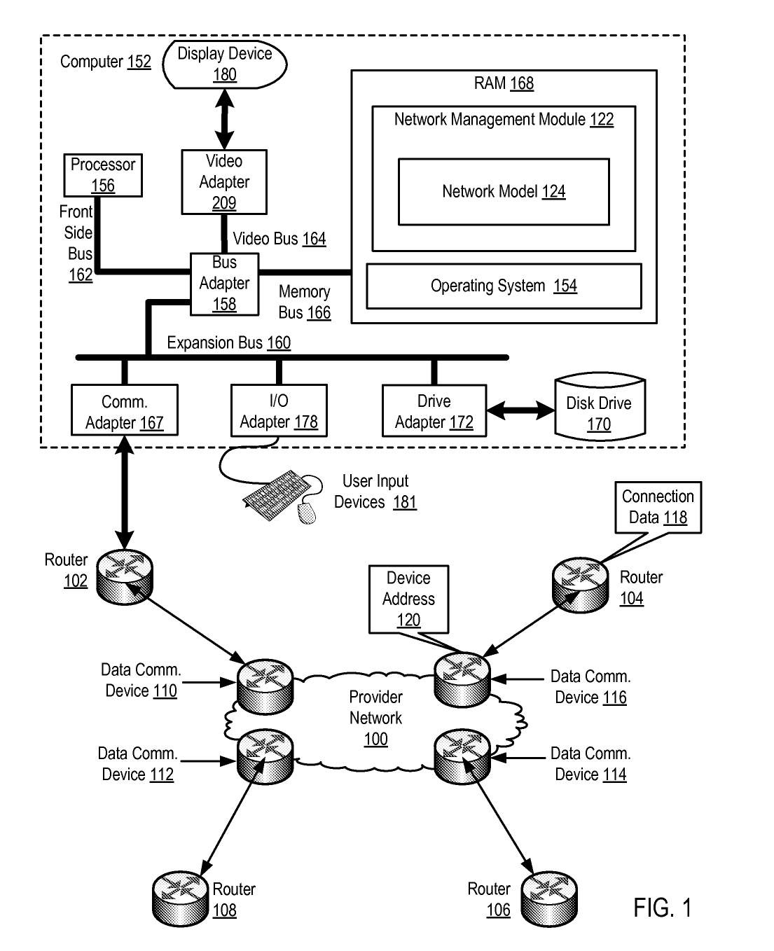

Exemplary methods, apparatus, and products for inferred discovery of devices of a data communications network in accordance with the present invention are described with reference to the accompanying drawings, beginning with FIG. 1. FIG. 1 sets forth a functional block diagram of an exemplary system capable of inferred discovery of devices of a data communications network according to embodiments of the present invention. The exemplary system of FIG. 1 includes a provider network (100) that includes several data communications devices (110, 112, 114, 116). A provider network is a data communications network connecting one or more customer network devices for data communications.

In the system of FIG. 1, the provider network (100) may be configured as a Multiprotocol Label Switching (‘MPLS’) network. MPLS is a data-carrying mechanism that belongs to the family of packet-switched networks. Customer devices connected through an MPLS network are typically configured as an MPLS Layer 3 virtual private network (‘L3VPN’). MPLS operates by pre-appending packets with an MPLS header containing one or more labels. This header is called a label stack. Each label stack entry contains four fields including:
a 20-bit label value;
a 3-bit field for Quality of Service (‘QoS’) priority;
a 1-bit bottom of stag flag signifying that the current label is the last in the stack; and
an 8-bit time to live (‘TTL’) field.

MPLS-labeled packets are switched according to a Label Lookup/Switch instead of a lookup into an IP table. That is, MPLS packets are switched according to a label, not an IP address. MPLS operates at an OSI model layer that is generally considered to lie between traditional definitions of the Layer 2-data link layer, and the Layer 3-network layer. MPLS was designed to provide a unified data-carrying service for both circuit-based clients and packet-switching clients which provide a datagram service model. MPLS can be used to carry many different kinds of data communications traffic, including IP packets, as well as native ATM, SONET, and Ethernet frames. The provider network (100) is described here as an MPLS network for clarity, not for limitation. Readers of skill in the art will recognize that the provider network (100) may be configured according to any protocol including, for example, the Internet Protocol (‘IP’), the Open Shortest Path First (‘OSPF’) protocol, the Internal Border Gateway Protocol (‘IBGP’) and so on.

A data communications device capable of inferred discovery in accordance with embodiments of the present invention may be implemented as any device capable of data communications with a router, such as, for example, another router. In the system of FIG. 1 each of the data communications devices has a device address (120). A device address is an address that can be used by a management module to identify and monitor a data communications device, such as for example, an IP address.

The exemplary provider network (100) of FIG. 1 connects several customer routers (102, 104, 106, 108). The customer routers are connected to the data communications devices that are part of the provider network. A router is a data communications device that extracts from a received data communications packet, a destination of the packet and selects a path to route the packet. In the system of FIG. 1, each router has one or more network interfaces. A network interface is an interface that connects a network device, such as a router, a computer, or a switch, to other network devices. Examples of network interfaces include 802.11 wireless interfaces, Fibre Channel interfaces, Ethernet, Gigabit Ethernet interfaces, and so on as will occur to those of skill in the art.

In the system of FIG. 1 the data communications devices (110, 112, 116, 114) may be provider edge routers. An edge router is a router placed at the edge of a network and typically connects one network with another. Provider edge routers may connect customer routers through many devices within the provider network. Typically customer routers have little to no knowledge of the devices that make up the provider network. Also in the system of FIG. 1 the routers (102, 104, 106, 108) may be customer edge routers. A customer edge router is a router located at the edge of the customer network, typically connecting a customer network to a provider a network.

In some embodiments of the present invention the exemplary routers of FIG. 1 and the exemplary data communications devices of FIG. 1 are Border Gateway Protocol (‘BGP’) speakers. BGP is the core routing protocol of Internet. BGP operates by maintaining a table of IP networks or ‘prefixes’ which designate network reachability among autonomous system. An autonomous systems is a collection of IP networks and routers under the control of one or more entities that presents a common routing policy to the internet Routers connecting autonomous systems typically use external BGP as a protocol for routing data communications among the autonomous systems. In the system of FIG. 1, for example, the data communications devices placed at the edge of the provider network (100) may be external Border Gateway Protocol (‘eBGP’) speakers with the routers (102, 104, 106, 108) which may also be eBGP speakers. The routers and data communications devices of FIG. 1 are described here as BGP speakers for clarity, not for limitation. Readers of skill in the art will recognize that routers connected to data communications devices in accordance with embodiments of the present invention may be connected according to any communications protocol as will occur to those of skill in the art.

The exemplary computer (152) of FIG. 1 includes a network management module (122) stored in RAM (168). The network management module (122) is a module of computer program instructions capable of inferred discovery of devices of a data communications network according to embodiments of the present invention. The network management module (122) operates generally for inferred discovery of devices of a data communications network according to embodiments of the present invention by, for each router in the system of FIG. 1: querying each router for connection data (118), the connection data associating interfaces of the router with device addresses; identifying for each router in dependence upon the connection data an interface of the router connected to a data communications device including identifying a device address associated with the interface.

Connection data is data used by the router to route packets of data communication through the provider network (100). Such connection data may include an identification of the interfaces of the router associated with device addresses of devices which are connected to the identified interfaces. Connection data may also include user defined attributes that describe an interface. Such attributes may include, for example, an identification of interface of the router as a provider-facing interface.

The network management module (122) also operates for inferred discovery of devices of a data communications network by creating, in dependence upon the identified device addresses for all routers, a representation of the data communications network in a network model (124). A network model is a representation of network topology. Network models useful for inferred discovery of devices may be used to collect and distribute data communications and build and maintain knowledge about physical and logical network connectivity. A network model may additionally be used for root cause analysis when identifying an actual cause of a network problem. The management module (308) may create, in the network model, a representation of the data communications device by defining in the network model a single data communications device, specifying as interface addresses of the single data communications the identified device addresses, and defining connection between the interfaces and corresponding routers.

Also stored in RAM (168) is an operating system (154). Operating systems useful for inferred discovery of devices of a data communications network according to embodiments of the present invention include UNIX™, Linux™, Microsoft XP™, Microsoft Vista™, AIX™, IBM's i5/OS™, and others as will occur to those of skill in the art. The operating system (154) and the network management module (122), in the example of FIG. 1 are shown in RAM (168), but many components of such software typically are stored in non-volatile memory also, such as, for example, on a disk drive (170).

The exemplary computer (152) of FIG. 1 includes disk drive adapter (172) coupled through expansion bus (160) and bus adapter (158) to processor (156) and other components of the computer (152). Disk drive adapter (172) connects non-volatile data storage to the computer (152) in the form of disk drive (170). Disk drive adapters useful in computers for inferred discovery of devices of a data communications network according to embodiments of the present invention include Integrated Drive Electronics (‘IDE’) adapters, Small Computer System Interface (‘SCSI’) adapters, and others as will occur to those of skill in the art. Non-volatile computer memory also may be implemented for as an optical disk drive, electrically erasable programmable read-only memory (‘EEPROM’ or ‘Flash’ memory) (134), RAM drives, and so on, as will occur to those of skill in the art.

The exemplary computer (152) of FIG. 1 includes one or more input/output (‘I/O’) adapters (178). I/O adapters implement user-oriented input/output through, for example, software drivers and computer hardware for controlling output to display devices such as computer display screens, as well as user input from user input devices (181) such as keyboards and mice. The example computer (152) of FIG. 1 includes a video adapter (209), which is an example of an I/O adapter specially designed for graphic output to a display device (180) such as a display screen or computer monitor. Video adapter (209) is connected to processor (156) through a high speed video bus (164), bus adapter (158), and the front side bus (162), which is also a high speed bus.

The exemplary computer (152) of FIG. 1 includes a communications adapter (167) that couples the computer for data communications with other servers in the data center through a data communications network (100). Such a data communication network (100) may be implemented with external buses such as a Universal Serial Bus (‘USB’), or as an Internet Protocol (‘IP’) network or an Ethernet™ network, an I²C network, a System Management Bus (‘SMBus’), an Intelligent Platform Management Bus (‘IPMB’), for example, and in other ways as will occur to those of skill in the art. Communications adapters implement the hardware level of data communications through which one computer sends data communications to another computer, directly or through a data communications network. Examples of communications adapters useful for inferred discovery of devices of a data communications network according to embodiments of the present invention include modems for wired dial-up communications, Ethernet (IEEE 802.3) adapters for wired data communications network communications and 802.11 adapters for wireless data communications network communications.

The arrangement of servers and other devices making up the exemplary system illustrated in FIG. 1 are for explanation, not for limitation. Data processing systems useful according to various embodiments of the present invention may include additional servers, routers, other devices, and peer-to-peer architectures, not shown in FIG. 1, as will occur to those of skill in the art. Networks in such data processing systems may support many data communications protocols, including for example TCP (Transmission Control Protocol), IP (Internet Protocol), HTTP (HyperText Transfer Protocol), WAP (Wireless Access Protocol), HDTP (Handheld Device Transport Protocol), and others as will occur to those of skill in the art. Various embodiments of the present invention may be implemented on a variety of hardware platforms in addition to those illustrated in FIG. 1.

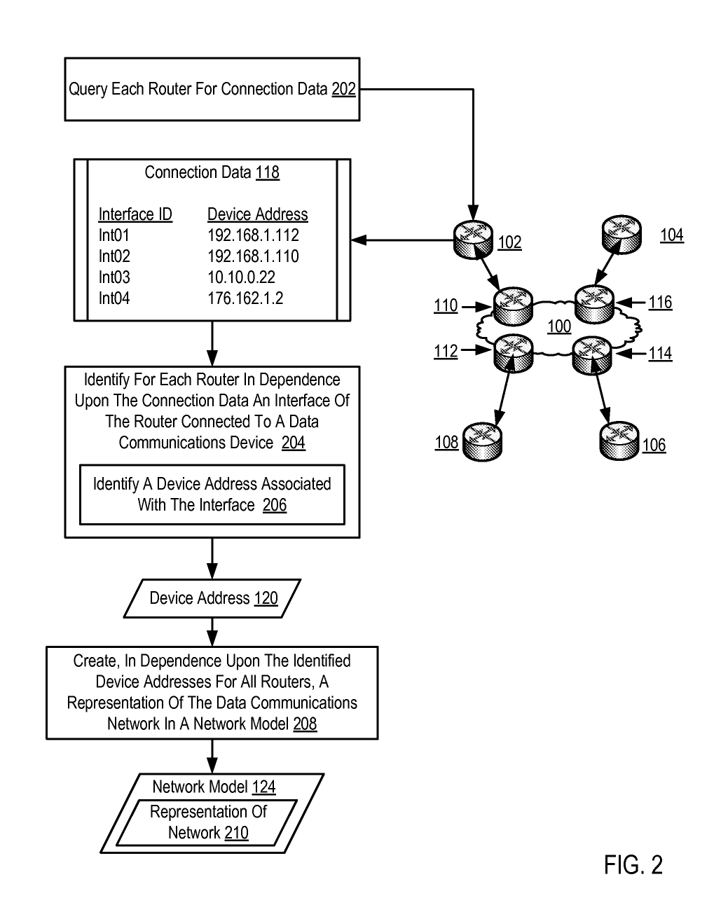

For further explanation, FIG. 2 sets forth a flow chart illustrating an exemplary method for inferred discovery of devices of a data communications network according to embodiments of the present invention. The data communications network (100) in the method of FIG. 2 includes a plurality of data communications devices (110, 112, 114, 116) connecting a plurality of routers (102, 104, 106, 108). Each data communications device in the method of FIG. 2 has a device address (120) and each router has one or more network interfaces.

The method of FIG. 2 includes querying (202) each router (102) for connection data (118). In the method of FIG. 2, the connection data (118) associates interfaces of the router (102) with device addresses (120). The connection data (118) in the method of FIG. 2, for example, includes a column title ‘Interface ID’ and a column title ‘Device Address.’ The column titled ‘Interface ID’ includes several elements, each element identifying a unique interface on the router (102). The column title ‘Device Address’ includes several elements, each element identifying a device address associated with the unique address. In the exemplary connection data (118) of FIG. 2, for example, the interface identified as ‘Int01’ is associated with the IP address 192.168.1.112.

Querying (202) each router (102) for connection data (118) may be carried out by transmitting a Simple Network Management Protocol (‘SNMP’) request from a network management module to a master agent running on the router. SNMP is a protocol that forms part of the internet protocol suite as defined by the Internet Engineering Task Force (‘IETF’). SNMP is typically used by network management systems to monitor network-attached devices for conditions that warrant administrative attention. SNMP consists of a set of standards for network management, including an Application Layer protocol, a database schema, and a set of data objects. SNMP exposes management data in the form of variables on a managed system, which describes the system configuration. These variables can be queried and sometimes set by a managing application. An master agent is a software component that typically runs on an SNMP-capable network component, such as a router, for example, and includes computer program instructions capable of responding to SNMP request from a management station, such as a network management module. The master agent therefore acts as a server in a client-server architecture or in a manner similar to a daemon in an operating system.

SNMP specifies several different requests that may be transmitted to a master agent including for example:
GET REQUEST—a request used to retrieve a piece of management information.
GETNEXT REQUEST—a request used iteratively to retrieve sequences of management information.
GETBULK REQUEST—a faster iterative request used to retrieve sequences of management information.
SET REQUEST—used to initialize and make a change to a value of the network element.

A management module may use any of the ‘GET’ requests above to query the router for connection data. In response to a SNMP request the master agent returns the connection data. The master agent may return the connection data in a SNMP response such as, for example, a GET RESPONSE. A GET RESPONSE is used by the master agent to respond with data to ‘GET’ requests from the manager. Querying a router for connection data is described as being carried out according to SNMP for clarity, not for limitation. Readers of skill in the art will recognize that querying a router may be carried out according to other protocols including, for example, Secure Shell (‘SSH’), Telecommunication Network protocol (‘TELNET’), and so on.

The method of FIG. 2 also includes identifying (204) for each router in dependence upon the connection data (118) an interface of the router (102) connected to a data communications device (110) including identifying (206) a device address (120) associated with the interface. Identifying (204) in dependence upon the connection data (118) an interface of the router (102) connected to a data communications device (110) including identifying a device address (120) may be carried out in various ways. Identifying (204) an interface of the router may, for example, be carried out by determining in dependence upon the connection data the interface of the router associated with a device address matching a device address in a preconfigured set of possible device addresses. A network administrator may have specify a set of device addresses, a range of IP addresses, for example, that are provider device addresses. The network management module may compare the connection data, specifically the device addresses listed in the connection data, with the set of device addresses specified as provider device addresses to identify a device address in the connection data that matches a device address in the set of device addresses specified as provider device addresses. When the network management module identifies a matching device address, the network management module then identifies an interface of the router associated with the matching device address.

Identifying (204) an interface of the router (102) connected to a data communications device (110) may also be carried out by determining in dependence upon the connection data the interface of the router having a predefined attribute. As mentioned above, connection data may include, in addition to device addresses and interface identifications, user specified attributes. A network administrator may, for example, specify as an attribute of an interface of a router that the interface is a provider-facing interface.

Identifying (204) an interface of the router (102) connected to a data communications device (110) may also be carried out through a process of elimination by identifying from the connection data all interfaces connected to devices that are not included in the data communications network; identifying all non-connected interfaces; and identifying the remaining interface as the interface of the router connected to the data communications device of the data communications network. In embodiments in which the router and the data communications device are edge routers, for example, the router is typically only connected to one provider device, the data communications device. All other devices, being owned, operated, and managed by the customer use known interfaces of the router. The only connected interface not connected to a known device is typically an interface connected to a provider device.

The method of FIG. 2 also includes creating, in dependence upon the identified device addresses for all routers, a representation of the data communications network in a network model. The network management module may create a representation of the data communications network by modeling the network as a single data communications device having several interfaces, each interface having a device address corresponding to a device address one of the data communications devices in the data communications network. The network model also models connections between routers and the data communications devices by modeling connections between the routers and an interface of the single data communications device representing the data communications network having a device address that corresponds to the actual data communications device to which the router is connected.

Exemplary embodiments of the present invention are described largely in the context of a fully functional computer system for inferred discovery of devices of a data communications network. Readers of skill in the art will recognize, however, that the present invention also may be embodied in a computer program product disposed on signal bearing media for use with any suitable data processing system. Such signal bearing media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets™ and networks that communicate with the Internet Protocol and the World Wide Web as well as wireless transmission media such as, for example, networks implemented according to the IEEE 802.11 family of specifications. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of inferred discovery of devices of a data communications network, the data communications network comprising a plurality of data communications devices connecting a plurality of routers, each data communications device having a device address, each router having one or more network interfaces, the method comprising:
querying each router for connection data, the connection data associating interfaces of the router with device addresses;
identifying for each router in dependence upon the connection data an interface of the router connected to a data communications device including identifying a device address associated with the interface; and
creating, in dependence upon the identified device addresses for all routers, a representation of the data communications network in a network model.

2. The method of claim 1 wherein identifying in dependence upon the connection data an interface of the router connected to a data communications device further comprises:
determining in dependence upon the connection data the interface of the router associated with a device address matching a device address in a preconfigured set of possible device addresses.

3. The method of claim 1 wherein identifying in dependence upon the connection data an interface of the router connected to a data communications device further comprises:
determining in dependence upon the connection data the interface of the router having a predefined attribute.

4. The method of claim 1 wherein identifying in dependence upon the connection data an interface of the router connected to a data communications device further comprises:
identifying from the connection data all interfaces connected to devices that are not included in the data communications network;
identifying all non-connected interfaces; and
identifying the remaining interface as the interface of the router connected to the data communications device of the data communications network.

5. The method of claim 1 wherein the plurality of routers comprise customer edge routers and the plurality of data communications devices comprise provider edge routers.

6. The method of claim 1 wherein the data communications network comprises a Multiprotocol Label Switching (‘MPLS’) network.

7. The method of claim 1 wherein the plurality of routers and the plurality of data communications devices are Border Gateway Protocol (‘BGP’) speakers.

8. An apparatus for inferred discovery of devices of a data communications network, the data communications network comprising a plurality of data communications devices connecting a plurality of routers, each data communications device having a device address, each router having one or more network interfaces, the apparatus comprising a computer processor, a computer memory operatively coupled to the computer processor, the computer memory having disposed within it computer program instructions capable of:
querying each router for connection data, the connection data associating interfaces of the router with device addresses;
identifying for each router in dependence upon the connection data an interface of the router connected to a data communications device including identifying a device address associated with the interface; and
creating, in dependence upon the identified device addresses for all routers, a representation of the data communications network in a network model.

9. The apparatus of claim 8 wherein identifying in dependence upon the connection data an interface of the router connected to a data communications device further comprises:
determining in dependence upon the connection data the interface of the router associated with a device address matching a device address in a preconfigured set of possible device addresses.

10. The apparatus of claim 8 wherein identifying in dependence upon the connection data an interface of the router connected to a data communications device further comprises:
determining in dependence upon the connection data the interface of the router having a predefined attribute.

11. The apparatus of claim 8 wherein identifying in dependence upon the connection data an interface of the router connected to a data communications device further comprises:
identifying from the connection data all interfaces connected to devices that are not included in the data communications network;
identifying all non-connected interfaces; and
identifying the remaining interface as the interface of the router connected to the data communications device of the data communications network.

12. The apparatus of claim 8 wherein the plurality of routers comprise customer edge routers and the plurality of data communications devices comprise provider edge routers.

13. The apparatus of claim 8 wherein the data communications network comprises a Multiprotocol Label Switching (‘MPLS’) network.

14. The apparatus of claim 8 wherein the plurality of routers and the plurality of data communications devices are Border Gateway Protocol (‘BGP’) speakers.

15. A computer program product for inferred discovery of devices of a data communications network, the data communications network comprising a plurality of data communications devices connecting a plurality of routers, each data communications device having a device address, each router having one or more network interfaces, the computer program product disposed in a computer readable medium, the computer program product comprising computer program instructions capable of:
querying each router for connection data, the connection data associating interfaces of the router with device addresses;
identifying for each router in dependence upon the connection data an interface of the router connected to a data communications device including identifying a device address associated with the interface; and
creating, in dependence upon the identified device addresses for all routers, a representation of the data communications network in a network model.

16. The computer program product of claim 15 wherein identifying in dependence upon the connection data an interface of the router connected to a data communications device further comprises:
determining in dependence upon the connection data the interface of the router associated with a device address matching a device address in a preconfigured set of possible device addresses.

17. The computer program product of claim 15 wherein identifying in dependence upon the connection data an interface of the router connected to a data communications device further comprises:
determining in dependence upon the connection data the interface of the router having a predefined attribute.

18. The computer program product of claim 15 wherein identifying in dependence upon the connection data an interface of the router connected to a data communications device further comprises:
identifying from the connection data all interfaces connected to devices that are not included in the data communications network;
identifying all non-connected interfaces; and
identifying the remaining interface as the interface of the router connected to the data communications device of the data communications network.

19. The computer program product of claim 15 wherein the plurality of routers comprise customer edge routers and the plurality of data communications devices comprise provider edge routers.

20. The computer program product of claim 15 wherein the data communications network comprises a Multiprotocol Label Switching (‘MPLS’) network.
